(19) United States
(12) Patent Application Publication
(10) Pub. No.: US 2016/0025249 A1
(43) Pub. Date: Jan. 28, 2016

(54) CONNECTOR WITH MATING PLATE

(71) Applicant: ORIDION MEDICAL 1987 LTD., Jerusalem (IL)

(72) Inventor: Seamus MAGUIRE, Athlone (IE)

(21) Appl. No.: 14/337,263

(22) Filed: Jul. 22, 2014

(51) Int. Cl. F16L 15/08

(52) U.S. Cl. CPC F16L 15/08

(57) ABSTRACT

A breath sampling line connector including a housing and a first mating plate, the first mating plate having a non-circular orifice and a geometric feature, the geometric feature configured to determine an alignment of the first mating plate relative to a second mating plate of a mating connector; wherein the alignment determines a cross sectional area of the non-circular orifice.

### TECHNICAL FIELD

The present disclosure relates generally to the field of connectors for connection of breath sampling tubes to a sampling line.

### BACKGROUND

In side stream gas sampling there is a portion of tubing (sampling line) that interfaces between the gas analyzer and the patient. There is typically at least one connection along this portion of tubing, at either end, to allow connection of the tubing at some point between the gas analyzer and the patient. This is typically done using double sided connectors.

There may be times when the gas analysis system needs to identify certain characteristics of the tubing which may influence the operation mode of the gas analyzer.

### SUMMARY

Aspects of the disclosure, in some embodiments thereof, relate to connectors configured to connect between two sections of tubings where the action of connection causes a change in a mechanical parameter within the connector.

Often, there is a need to identify characteristics of the tubing that interfaces between the analyzer and the patient, such as the length of the tube, the diameter of the tube, or constituents connected to the tube. However, as the tubes are often of the disposable type, incorporating identification means may be cost prohibitive. Advantageously, the connector, disclosed herein, provide a low cost mechanical means for tube identification enabling differentiation of tubes having different characteristics.

Accordingly, aspects of the disclosure are directed to connectors which may facilitate identification of the connector (and hence the constituent attached thereto) as belonging to a certain type. This may again be utilized to automatically actuate the medical instrument in an operation mode suitable to the identified connector.

According to some embodiments, there is provided a breath sampling line connector having a housing and a first mating plate, the first mating plate including a non-circular orifice and a geometric feature. According to some embodiments, the geometric feature may be configured to determine an alignment of the first mating plate relative to a second mating plate of a mating connector. According to some embodiments, the alignment may determine a cross sectional area of the non-circular orifice.

According to some embodiments, the first mating plate may be configured to rotate within said housing. According to some embodiments, the first mating plate may be configured to be fixed within the housing. According to some embodiments, the first mating plate may be spring loaded. According to some embodiments, the housing may include threads configured to mate with threads on a housing of said mating connector.

According to some embodiments, the geometric feature may include steps.

According to some embodiments, the non-circular orifice may be an oval orifice. According to some embodiments, the second mating plate may include an oval orifice.

According to some embodiments, the cross sectional area of the non-circular orifice may be configured to determine a gas flow rate through the non-circular orifice. According to some embodiments, a connection system may be configured to detect the gas flow rate. According to some embodiments, the connection system may include a flow meter.

According to some embodiments, the gas flow rate may be indicative of a parameter of a tube attached to the connector. According to some embodiments, the parameter may include tube length, tube diameter, presence of filters or any combination thereof.

According to some embodiments, the gas flow rate may be indicative of a preferred mode of operation of the connector.

According to some embodiments, the connector may be configured to connect to a medical device.

According to some embodiments, there is provided a method including forming a connector having a housing and a first mating plate, the first mating plate having a non-circular orifice and a geometric feature. According to some embodiments, the geometric feature may be configured to determine an alignment of the first mating plate relative to a second mating plate of a mating connector. According to some embodiments, the alignment may determine a cross sectional area of the non-circular orifice.

According to some embodiments, forming the connector may include attaching molding or embedding the mating plate within the housing.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

### BRIEF DESCRIPTION OF THE DRAWINGS

Some embodiments of the disclosure are described herein with reference to the accompanying figures. The description, together with the figures, makes apparent to a person having ordinary skill in the art how some embodiments of the disclosure may be practiced. The figures are for the purpose of illustrative discussion and no attempt is made to show structural details of an embodiment in more detail than is necessary for a fundamental understanding of the teachings of the disclosure. For the sake of clarity, some objects depicted in the figures are not to scale.

FIG. 1 schematically illustrates a perspective view of an exemplary connector, according to some embodiments;

FIG. 2 schematically illustrates a perspective view of an exemplary connector, according to some embodiments;

FIG. 3 schematically illustrates an interconnection of exemplary mating connectors, according to some embodiments;

FIG. 4 schematically illustrates a perspective view of a mating plate, according to some embodiments.

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

The present disclosure relates generally to connectors for connection of sampling lines interfacing between a gas analyzer and a patient, where the action of connection causes a change in a mechanical parameter within the connector. In particular, the connectors may be suitable for interconnection of portions of a sampling line that is not at the end of the tube and which is not directly plugged into the gas analyzer.

As used herein, the terms “breath sampling tube”, “sampling line” and “breath sampling line” may refer to any type of tubing(s) or any part of tubing system adapted to allow the flow of sampled breath, for example, to a breath analyzer, such as a capnograph. The sampling line may include tubes of various diameters, adaptors, valves, drying elements (such as filters, traps, trying tubes, such as Nafion® and the like).

As referred to herein, the terms “patient” and “subject” may interchangeably be used and may relate to a subject being monitored by a gas analyzer. According to some embodiments, the gas analyzer is a capnograph.

According to some embodiments, there is provided a breath sampling line connector including a housing and a first mating plate. As used herein, the term “mating plate” may refer to a disc or other attribute configured to mate with a similar element of a mating connector.

According to some embodiments, the first mating plate has an orifice and a geometric feature. As used herein, the term “geometrical feature” may refer to any element embedded in, molded on or otherwise attached to the mating plate, which is configured to determine the alignment of the opposing mating plates based on its geometric shape and/or size. According to some embodiments, the geometrical feature may be configured to determine an alignment of the first mating plate relative to a second mating plate of a mating connector. According to some embodiments, the geometric feature may be arranged to determine a degree of rotation of the first mating plate relative to a second mating plate of a mating connector. Hence, as the housings of two mating connectors are twisted to lock them together, the first mating plate may contact the opposing second mating plate. In effect, the mating plates may rotate relative to each other in order to achieve a proper alignment between the opposing mating plates. The degree of rotation of the opposing plates within the housing and/or the final alignment may be determined by the geometric feature of the opposing plates. That is, the opposing mating plates may align at a certain relative configuration depending on the alignment of the geometric feature. In turn, the alignment of the opposing mating plates may determine the cross sectional area of the resulting combined orifice.

According to some embodiments, the first mating plate may be configured to rotate within its housing. Alternatively, the first mating plate may be fixed within its housing. According to some embodiments, the first mating plate may be spring loaded. According to some embodiments, the opposing mating plate may be spring loaded. Thus, according to some embodiments, as the housing of two mating connectors are twisted to lock them together, the first mating plate may rotate relative to the second mating plate (which may be fixed), the second mating plate may rotate relative to the first mating plate (which may be fixed) or both first and second mating plates may rotate relative to each other. Each possibility is a separate embodiment.

According to some embodiments, the geometric feature may include more than one geometric feature, such as but not limited to 2, 3, 4, 5 or more geometrical features. Each possibility is a separate embodiment.

According to some embodiments, the geometric feature may include steps within the mating plate. According to some embodiments, the steps may be of various height and width. According to some embodiments, the geometric feature may be an indent within the mating plate. According to some embodiments, the indent may be of various depth and width. According to some embodiment, the geometric feature may be a protrusion in the mating plate. According to some embodiments, the geometric feature may be a depression in the mating plate. According to some embodiments, the geometric feature may be of any shape or configuration that may enable a distinct alignment of the opposing mating plates.

According to some embodiments, the orifice of the first mating plate is a non-circular orifice. According to some embodiments, the orifice of the first mating plate is an oval or elliptical orifice. According to some embodiments, the second mating plate may include a second orifice. According to some embodiments, the second orifice may be a non-circular orifice, such as but not limited to an oval/elliptical orifice. According to some embodiments, the first and second orifices are identical. According to some embodiments, the orifices are distinct.

According to some embodiments, the alignment of the mating plates generates a combined orifice. According to some embodiments, the cross sectional area of the combined orifice is determined by the relative rotation of the opposing mating plates. According to some embodiments, the cross sectional area of the combined orifice is determined by the relative alignment of the opposing mating plates.

According to some embodiments, the cross sectional area of the combined orifice may change when two non-oval orifices rotate relative to one another. For example, if the opposing mating plates are not rotated or if they are rotated a full rotation one relative to the other, the non-circular orifices may be aligned thereby generating a combined orifice with a maximum sized cross sectional area. Alternatively, if the opposing mating plates are rotated less (or more) than a full rotation relative to one another, the cross sectional area of the combined orifice is reduced, reaching a minimum when the opposing orifices are orthogonal to one another.

According to some embodiments, the cross sectional area of the combined orifice is determined by the relative position of the non-oval orifices and the geometrical orifice. For example if the alignment of two opposing mating plates results in a parallel alignment of the opposing orifices of the mating plates, the cross-sectional area of the combined orifice is of a maximum size. Alternatively, if the alignment, of two opposing mating plates, results in a non-parallel alignment of the opposing orifices of the mating plates the cross-sectional area of the combined orifice is reduced, reaching a minimum when the opposing orifices are orthogonal to one another.

According to some embodiment, the mating plate may be a universal mating plate. As used herein, the term “universal mating plate” may refer to a mating plate configured to align with a plurality of non-universal mating plates, in such manner that the rotation of the universal mating plate relative to the non-universal mating plate, and thus the cross-sectional area of the combined orifices, depends on the geometrical feature of the specific non-universal mating plate to which the universal mating plate is aligned. According to some embodiments, the universal mating plate may have a plurality of predefined alignments conditions.

As used herein, the term “plurality” may refer to 2, 3, 4, 5, 10 or more predefined alignment conditions.

According to some embodiments, the connector including the universal mating plate may be connected to a gas analyzer (such as but not limited to a capnograph), whereas connectors connected to tubes or other constituents may include non-universal mating plates, each non-universal mating plate specific to a specific constituent (e.g. a specific sampling tube). According to some embodiments, the universal mating plate may be rotatable within its housing whereas the specific non-universal mating plates may be fixed within their housing. However, the opposite configuration in which the universal mating plate is fixed and the specific non-universal mating plates are rotatable is likewise applicable and as such fall within the scope of this disclosure. Similarly, both the connector including the universal mating plate and the connector with the non-universal mating plate may be rotatable within their respective housing.

According to some embodiments, the mating connectors may be configured to interconnect portions of a sampling line that is not at the end of the tube and which is not directly plugged into the gas analyzer. Accordingly, it may, under such circumstances, be advantageous to utilize connectors having non-universal mating plates only. Alternatively, the connector connected to the tube line at the end of the line most proximal to the gas analyzer may include the universal connector. As used herein, the term “the end most proximal to the gas analyzer” may refer to the portion of a sampling line which at one end thereof is directly plugged into the gas analyzer.

According to some embodiments, the cross sectional area of the combined orifice may determine a gas flow rate through the orifice. According to some embodiments, the cross sectional area of the combined orifice may determine a pressure of the gas flowing through the orifice. According to some embodiments, the cross sectional area of the combined orifice may determine a flow resistance through the orifice. According to some embodiments, changes in the gas flow rate, the gas pressure or the resistance may be detected by a connection system. It is thus understood that the combined orifice diameter created by the mating of the mating plates may be communicated to the connection system by it measuring the flow, changes in flow, pressure, pressure changes, resistance or changes in resistance in the sampling line. Each possibility is a separate embodiment.

According to some embodiments, the connection system may include a flow meter. According to some embodiments, the connection system may include a pressure meter. According to some embodiments, the connection system may include a sensor configured to measure the resistance in the sampling line.

According to some embodiments, the gas flow rate measured may be indicative of a class or type of the tube attached to the connector. As referred to herein the term “type”, “model”, “class” of the connector may interchangeably be used and may relate to the interface to be used with the connector. According to some embodiments, the connection system may be configured to distinguish between different classes of connectors. As a non-limiting example, the connection system may be configured to identify a connector attached to a sampling tube adapted for use with infants and to distinguish between this connector and a connecter attached to a sampling tube adapted for use in adults.

According to some embodiments, the gas flow rate, the gas pressure or the resistance measured may be indicative of a tube parameter. According to some embodiments, suitable tube parameters include, but are not limited to, tube length, tube diameter, presence of filters or any combination thereof. Each possibility is a separate embodiment. As a non-limiting example, the connection system may be configured to identify a connector as being connected to a tube including a filter, based on the identified gas flow rate, gas pressure, resistance, combinations thereof or changes therein. Each possibility is a separate embodiment.

According to some embodiments, the gas flow rate, the gas pressure or the resistance measured may be indicative of a preferred mode of operation of the gas analyzer when connected to a tube of a certain class/type.

According to some embodiments, the housing may include threads configured to mate with threads on a housing of the mating connector. For example, the threads may assist in screwing and/or twisting two mating connectors when locked together.

According to some embodiments, there is provided a method including forming a connector having a housing and a first mating plate. According to some embodiments, the first mating plate may include an orifice and a geometric feature. According to some embodiments, the geometrical feature may be configured to determine an alignment of the first mating plate relative to a second mating plate of a mating connector. According to some embodiments, the geometrical feature may be configured to determine an alignment of the first mating plate relative to a second mating plate of a mating connector. According to some embodiments, the geometric feature may be arranged to determine a degree of rotation of the first mating plate relative to a second mating plate of a mating connector.

According to some embodiments, forming may include attaching molding or embedding the mating plate within the housing.

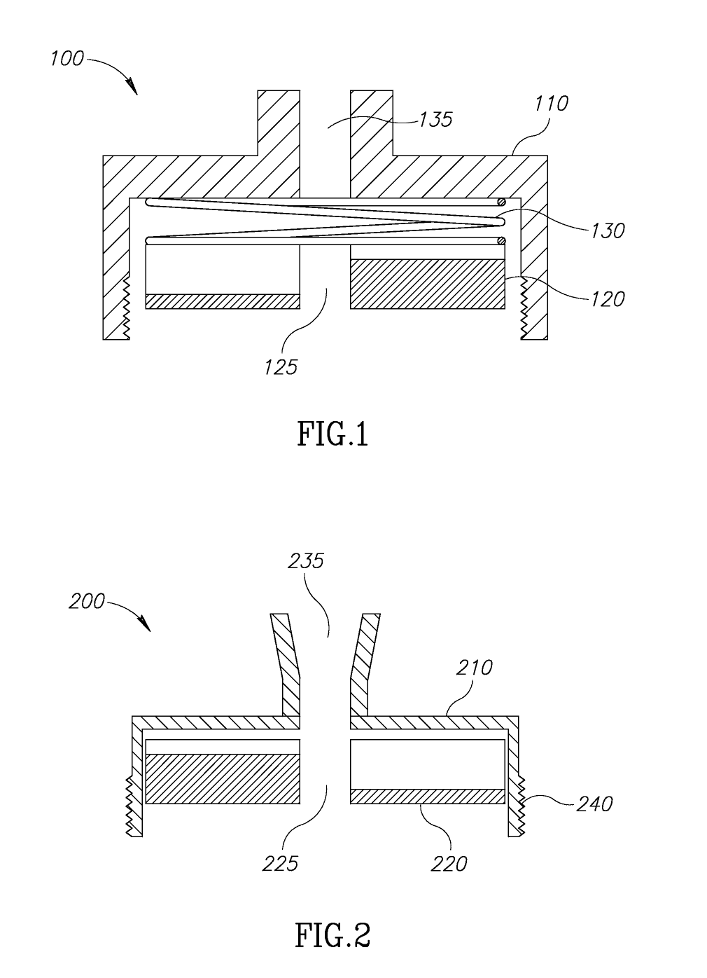

Reference is now made to FIG. 1, which schematically illustrates a perspective view of an exemplary connector, according to some embodiments. Connector 100 (which may be a male or a female connector, such as, but not limited to, a male or female Luer connector) includes a housing 110 and therewithin a mating plate 120. Mating plate 120 is spring loaded through spring 130. Mating plate 120 is configured to rotate within housing 110 during connection of connector 100 to a mating connector (not shown). Mating plate 120 includes a non-circular orifice 125 (such as an oval orifice) configured to allow breath entering connector 100 through channel 135 of housing 110 to proceed flowing through orifice 125 (or vice versa). Mating plate 120 further includes geometrical features (here steps depicted as shaded and non-shaded areas), as further elaborated in FIG. 4.

Reference is now made to FIG. 2, which schematically illustrates a perspective view of an exemplary connector, according to some embodiments. Connector 200 (which may be a male or a female connector, such as, but not limited to, a male or female Luer connector) includes a housing 210 and therewithin a mating plate 220. Mating plate 220 is fixed to housing 210 and does therefore not rotate within housing 210 during connection of connector 200 to a mating connector (not shown). Mating plate 220 includes a non-circular orifice 225 (such as but not limited to an oval orifice) configured to allow breath entering connector 200 through channel 235 of housing 210 to proceed flowing through orifice 225 (or vice versa). Mating plate 220 further includes geometrical features (here steps depicted as shaded and non-shaded areas), as further elaborated in FIG. 4. Housing 210 further includes threads 240 on an outer portion of housing 210. Threads 240 are configured to assist in securely screwing housing 210 into the housing of the mating connector.

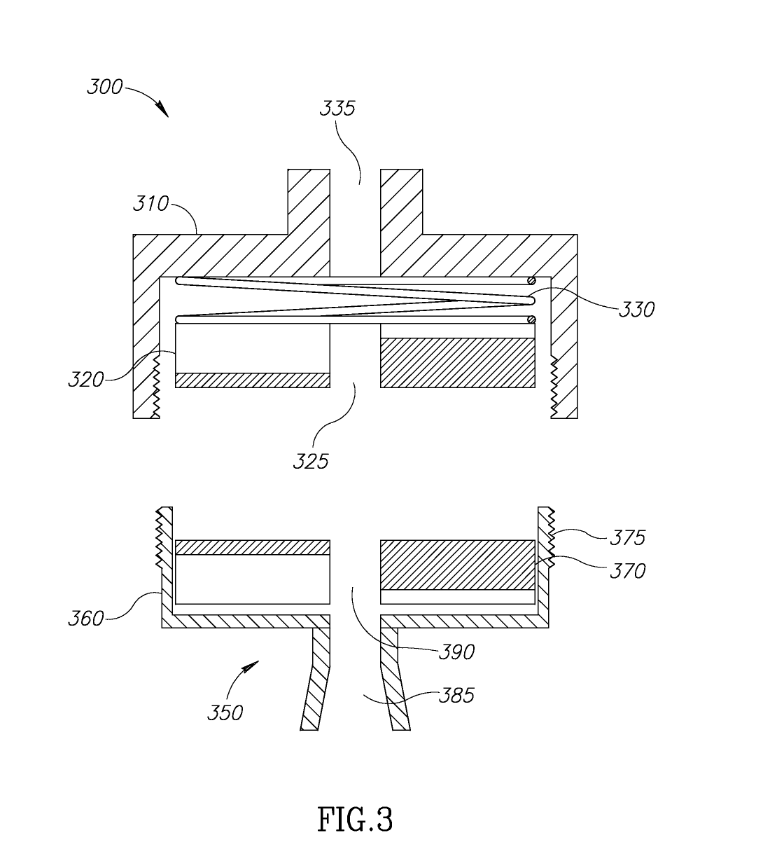

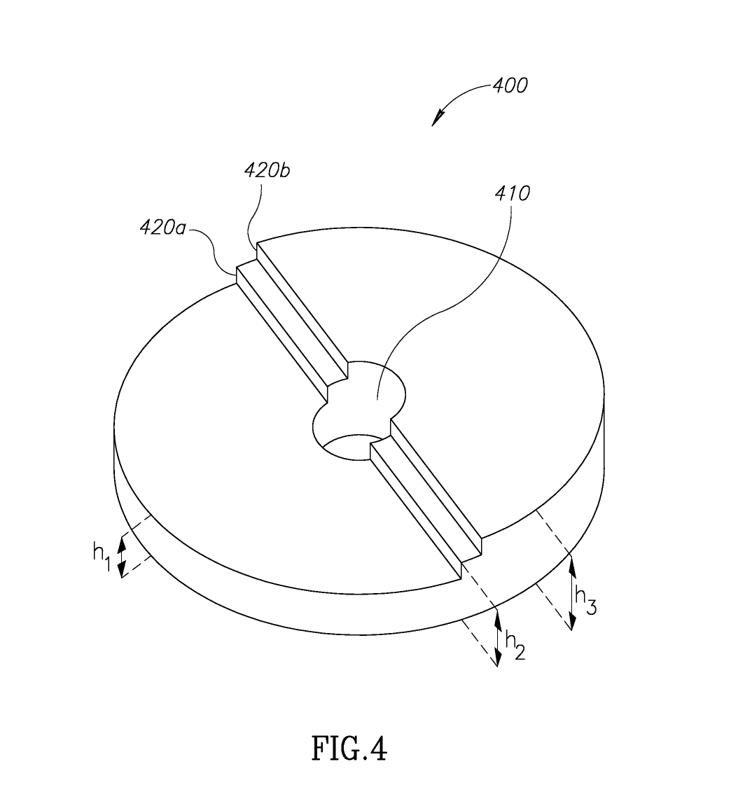

Reference is now made to FIG. 3, which schematically illustrates a perspective view of two exemplary mating connectors, according to some embodiments. The mating connectors include a first connector 300 (here a female connector) and a mating second connector 350. First connector 300 includes a housing 310 and therewithin a mating plate 320. Mating plate 320 is spring loaded through spring 330. Mating plate 320 is configured to rotate within housing 310 during connection of first connector 300 relative to second connector 350. Second connector 350 includes a housing 360 and therewithin a mating plate 370. Mating plate 370 is fixed within housing 360 and does therefore not rotate therewithin. During the twisting, screwing and/or pushing of connectors 300 and 350 when connected, mating plate 320 interacts with mating plate 370. In effect mating plate 320 rotates relative to mating plate 370 until an alignment between the geometrical features (here steps depicted as shaded and non-shaded areas) of each of mating plates 320 and mating plate 370 is achieved. Mating plate 320 and mating plate 370 include non-circular orifices 325 and 390, respectively configured to allow breath entering connector 300 through channel 335 of housing 310 to proceed flowing through orifices 325 and 390 and further through channel 385 of housing 360 of connector 350 (or vice versa). Due to the non-circular cross-sectional area of orifices 325 and 390, the rotation of mating plate 320 relative to mating plate 370 determines the cross-sectional area of the combined orifice, as further described herein. Housing 360 further includes threads 375 on an outer portion thereof. Threads 375 are configured to assist in securely screwing housing 360 of second connector 350 into housing 310 of first connector 300. It is understood by one of ordinary skill in the art that first connector 300 may be connected to the gas analyzer, whereas second connector 350 may be connected to a constituent. However, the opposite configuration is likewise applicable as further described herein.

Reference is now made to FIG. 4, which schematically illustrates a perspective view of a mating plate, according to some embodiments. Mating plate 400 includes a noncircular orifice 410. Mating plate 400 further includes a geometrical feature, here steps 420a and 420b. It is understood that the number of steps, their individual height and width may vary among different mating plates. Accordingly, the particular geometrical features depicted (i.e. steps 420a and 420b) are serving an illustrative purpose only. Due to steps 420a and 420b, the height of mating plate 400 varies such that part of mating plate 400 has a height h1, which as a result of step 420a increases to h2, and subsequently to h3, as a result of step 420b. In effect, if mating plate 400 mates with an identical mating plate, at least one of the mating plates will rotate until a parallel alignment is achieved and the resulting combined orifice will have a cross-sectional area identical to that of orifice 410. Alternatively, if mating plate 400 mates with an opposing mating plate having identical geometrical features but a non-circular orifice orthogonal to orifice 410, at least one of the mating plates will rotate until an anti-parallel alignment is achieved, and the resulting combined orifice will therefore have a cross-sectional area smaller than that of orifice 410.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” or “comprising”, when used in this specification, specify the presence of stated features, integers, steps, operations, elements, or components, but do not preclude or rule out the presence or addition of one or more other features, integers, steps, operations, elements, components, or groups thereof.

While a number of exemplary aspects and embodiments have been discussed above, those of skill in the art will recognize certain modifications, additions and sub-combinations thereof. It is therefore intended that the following appended claims and claims hereafter introduced be interpreted to include all such modifications, additions and sub-combinations as are within their true spirit and scope.

1. A breath sampling line connector comprising a housing and a first mating plate, said first mating plate comprising a non-circular orifice and a geometric feature, said geometric feature configured to determine an alignment of said first mating plate relative to a second mating plate of a mating connector; wherein the alignment determines a cross sectional area of said non-circular orifice.

2. The connector of claim 1, wherein said first mating plate is configured to rotate within said housing.

3. The connector of claim 1, wherein said first mating plate is fixed within said housing.

4. The connector of claim 1, wherein said first mating plate is spring loaded.

5. The connector of claim 1, wherein said geometric feature comprises steps.

6. The connector of claim 1, wherein said non-circular orifice is an oval orifice.

7. The connector of claim 6, wherein said second mating plate comprises an oval orifice.

8. The connector of claim 1, wherein said cross sectional area of said non-circular orifice is configured to determine a gas flow rate through said non-circular orifice.

9. The connector of claim 8, wherein a connection system is configured to detect said gas flow rate.

10. The connector of claim 9, wherein said connection system comprises a flow meter.

11. The connector of claim 8, wherein said gas flow rate is indicative of a parameter of a tube attached to said connector.

12. The connector of claim 11, wherein said parameter comprises tube length, tube diameter, presence of filters or any combination thereof.

13. The connector of claim 8, wherein said gas flow rate is indicative of a preferred mode of operation of said connector.

14. The connector of claim 1, wherein said connector is configured to connect to a medical device.

15. The connector of claim 1, wherein said housing comprises threads configured to mate with threads on a housing of said mating connector.

16. A method comprising:
forming a connector comprising a housing and a first mating plate, the first mating plate comprising a non-circular orifice and a geometric feature, the geometric feature configured to determine an alignment of the first mating plate relative to a second mating plate of a mating connector; wherein the alignment determines a cross sectional area of said non-circular orifice.

17. The method of claim 16, wherein forming comprises attaching molding or embedding the mating plate within the housing.
